(19) United States
(12) Patent Application Publication
(10) Pub. No.: US 2004/0138909 A1
(43) Pub. Date: Jul. 15, 2004

(54) System and method for saving the rainforests

(76) Inventor: Yaron Mayer, Jerusalem (IL)

Correspondence Address: YARON MAYER, 21 AHAD HAAM ST., JERUSALEM, 92151, IL

(21) Appl. No.: 10/691,482

(22) Filed: Oct. 20, 2003

Related U.S. Application Data
(60) Provisional application No. 60/464,170, filed on Apr. 14, 2003.

(30) Foreign Application Priority Data
Oct. 20, 2002 (IL) 152369

(51) Int. Cl. G06F 17/60

(52) U.S. Cl. 705/1

(57) ABSTRACT

The destruction of the rainforests in the last decades has become the biggest crime against humanity, animals and Nature. Various statistics show that at the current rate of destruction, unless drastic changes are made right now, by the year 2020 or even considerably earlier, 90-100% of all the rainforests will be irrevocably destroyed, causing damages that will take MILLIONS OF YEARS to repair, if at all. The present invention tries to solve this by creating a strong financial incentive that makes preserving the rain forests much more profitable than destroying them. Preferably sustainable harvesting is combined with selling real acres to people and making sure that these acres are indeed under supervision and protection and that preferably as many of them as possible are also used for sustainable harvesting. This is preferably combined with a recursive multi-level marketing plan with various sophisticated improvements over the prior art.

### BACKGROUND OF THE INVENTION

1. Field of the Invention

The present invention relates to ecology, and more specifically to a System and method for saving the rainforests.

2. Background

The destruction of the rainforests in the last decades has become the biggest crime against humanity and against nature and against other entire species of animals, and also the biggest irreversible folly of the late 20^{th} century and beginning of the 21^{st}. Various statistics show that at the current rate of destruction, unless drastic changes are made right now, by the year 2020, 90-100% of all the rainforests will be irrevocably destroyed, causing damages that will take MILLIONS OF YEARS to repair, if at all. Not only that such changes have not been made so far, but the rate of destruction continually increases. Apart from the destruction of our natural resources, we are also murdering entire species, and the land itself typically becomes desert wasteland with eroded soil, where almost nothing can be grown anymore. For example, according to http://www.mongabay.com/0801.htm, “Tropical rainforests are incredibly rich ecosystems that play a fundamental role in the basic functioning of the planet, and are home to at least 50% of the world's species, making them an extensive library of biological and genetic resources. In addition, rainforests help maintain the climate by regulating atmospheric gases and stabilizing rainfall, protect against desertification, and provide numerous other ecological functions. However, these precious systems are among the most threatened on the planet. Although the precise area is disputed, each day, at least 80,000 acres (32,300 ha) of forest disappear from earth. At least another 80,000 acres (32,300 ha) of forest are degraded. Along with them, the planet loses as many as several hundred species to extinction, the vast majority of which have never been documented by science (species loss depends on the number of species on earth. If there are 30 million species, many more will disappear daily than if there are only 5 million species). As these forests disappear, more carbon is added to the atmosphere, climatic conditions are further altered, and more topsoil is lost to erosion. Worse, is that deforestation is not slowing, but increasing at an accelerated rate. During the 1980s the deforestation rate increased by 90% and deforestation in the Brazilian Amazon reached record proportions in 1995”. According to http://www.ran.org/info_center/factsheets/04b.html, the figures are much more severe: 2.4 acres (1 hectare) destroyed each second (Equivalent to two U.S. football fields), 149 acres (60 hectares) destroyed each minute, 214,000 acres (86,000 hectares) destroyed each day (An area larger than New York City), and 78 million acres (31 million hectares) destroyed each year (An area larger than Poland). In addition, according to http://www.ran.org/info_center/factsheets/03b.html (which quotes for example from Global Biodiversity Assessment, UNEP, Cambridge University Press, 1995, and from Wilson, Edward O., The Diversity of Life, Cambridge, Mass.: Harvard University Press, 1992), “The Earth's species are dying out at an alarming rate, up to 1000 times faster than their natural rate of extinction. By carefully examining fossil records and ecosystem destruction, some scientists estimate that as many as 137 [entire] species disappear from the Earth each day, which adds up to an astounding 50,000 species disappearing every year”. According to http://www.ran.org/info_center/factsheets/04b.html, rainforests are home to some 40 to 50 percent of all life forms on our planet—perhaps as many as 30 million species of plants, animals and insects. According to http://www.sumeria.net/earth/extinct.html, “More plant and animal species will go through extinction within our generation than have been lost through natural causes over the past two hundred million years. Our single human generation, that is, all people born between 1930 and 2010 will witness the complete obliteration of one third to one half of all the Earth's life forms, each and every one of them the product of more than two billion years of evolution. This is biological meltdown, and what this really means is the end to vertebrate evolution on planet Earth. Today, the tropical rain forests are disappearing more rapidly than any other bio-region, ensuring that after the age of humans, the Earth will remain a biological, if not a literal desert for eons to come. The present course of civilization points to ecocide—the death of nature. Like a run-a-way train, civilization is speeding along tracks of our own manufacture towards the stone wall of extinction. The choice is unique to this generation. Future generations will not have the chance and those that came before us did not have the vision nor the knowledge. It is up to us.”

According to http://worldforest.geo.msu.edu/rfrc/stats/wri/rank.html, the rainforests are divided among the following main countries, in descending order:

| Country | RainForest-Hectars |
|---|---|
| 1. Brazil | 291,597,000 |
| 2. Indonesia | 93,827,000 |
| 3. Congo | 60,437,000 |
| 4. Colombia | 47,455,000 |
| 5. Peru | 40,358,000 |
| 6. Papua New Guinea | 29,323,000 |
| 7. Venezuela | 19,602,000 |
| 8. Malaysia | 16,339,000 |
| 9. Myanmar | 12,094,000 |
| 10. Guyana | 11,671,000 |
| 11. Suriname | 9,042,000 |
| 12. India | 8,246,000 |
| 13. Cameroon | 8,021,000 |
| 14. French Guiana | 7,993,000 |
| 15. Congo, Rep | 7,667,000 |
| 16. Ecuador | 7,150,000 |
| 17. Madagascar | 4,507,000 |
| 18. Lao Republic | 3,960,000 |
| 19. Philippines | 3,728,000 |
| 20. Nicaragua | 3,712,000 |
| 21. Thailand | 3,082,000 |
| 22. Vietnam | 2,894,000 |
| 23. Guatemala | 2,542,000 |
| 24. Mexico | 2,441,000 |
| 25. Panama | 1,802,000 |
| 26. Belize | 1,741,000 |
| 27. Cambodia | 1,689,000 |
| 28. Honduras | 1,286,000 |
| 29. Nigeria | 1,197,000 |
| 30. Gabon | 1,155,000 |

So, clearly, most efforts should be preferably centered in the countries that lead the list, and most of all Brazil.

According to http://www.wildkids.org.uk/rainforest.htm, almost 90% of West Africa's rain forest has already been destroyed. According to Leslie Taylor's book, Herbal Secrets of the rainforests (published in the USA by Prima Health in 1998), in 1950 15% of the Earth's land surface was covered by rainforests, but today they cover only 6% or less. She also quotes a report that shows that for example in 1996 statistics showed a 34% increase in deforestation since 1992, and a new report by a congressional committee that shows that the Amazon is vanishing at a rate of 20,000 square miles each year, which is more than 3 times the rate of 1994. According to statistics that she quotes, over 200,000 acres of rainforests are burned every day, which is, again, much more than the 80,000 acres per day estimate quoted above. That is more than 150 acres lost every minute, and 78 million acres lost every year! According to her data, this massive deforestation and destruction brings with it many ugly consequences, including but not limited to: Air and water pollution, soil erosion, malaria epidemics, the release of more CO2 into the atmosphere, decrease of Oxygen for us to breathe, more increase in the global warming, and of course the irrevocable loss of huge biodiversity and with them the loss of many potentially highly important plants and medicines. According to her book, “rain forest plants are complex chemical storehouses that contain many undiscovered biodynamic compounds with unrealized potential for use in modern medicine. We can gain access to these materials only it we study and conserve the species that contain them. Rainforests currently provide sources providing one-fourth of today's medicines, and 70% of the plants found to have anti-cancer properties are found only in the rainforest. The Rainforest and its immense undiscovered biodiversity holds the key to unlocking tomorrow's cures for devastating diseases. How many cures to devastating disease have we already lost? Two drugs obtained from a rainforest plant known as the Madagascar periwinkle, now extinct in the wild due to deforestation of the Madagascar rainforest, has increased the chances of survival for children with leukemia from 20 percent to 80 percent. Think about it—8 out of 10 children are now saved rather than 8 of 10 children dying from leukemia. How many children have been spared and how many more will continue to be spared because of this single rainforest plant? What if we failed to discover this one important plant among millions before it was extinct due to man's destruction? When our remaining rainforests are gone, the rare plants, animals will be lost forever and so will their possible cures to diseases like cancer.” In addition, she quotes Robert Goodland of the World Bank, who wrote that “Indigenous knowledge is essential for the use, identification and cataloguing of the [tropical] biota. As tribal groups disappear, their knowledge vanishes with them. The preservation of these groups is a significant economic opportunity for the [developing] nation, not a luxury.” She quotes statistics that in 1500 there were an estimated six to nine million Indigenous People inhabiting the rainforests in Brazil. The Western conquistadors left behind decimated cultures, and by 1900 there were only one million Indigenous People left in Brazil's Amazon, and today there are less than 250,000 Indigenous People of Brazil surviving this catastrophe, and still it continues. These surviving Indigenous People still demonstrate the remarkable diversity of the rainforest because they comprise 215 ethnic groups with 170 different languages. They live in 526 territories nationwide, which together comprise an area of 190 million acres, twice the size of California. About 188 million acres of this land is inside the Brazilian Amazon, in the states of Acre, Amapa, Amazonas, Para, Mato Grosso, Maranhao, Rondonia, Roraima, and Tocantins. Also, according to her book, it is estimated that 20% of the Earth's oxygen is produced in the Amazon rainforest. Many times whole acres are destroyed just to get to a few Teac or Mahogany trees, which are then used for example to build coffins in the USA, that are then just buried or burned. The main two causes for the destruction are wood logging and cattle ranching.

Just to demonstrate the amount of Biodiversity being destroyed, she gives the following statistics. For example:

One hectare (2.47 acres) of rainforest may contain over 750 types of trees and 1500 species of higher plants;

A single pond in Brazil can sustain a greater variety of fish than are found in all of Europe's rivers;

A twenty-five acre plot of rainforest in Borneo may contain over seven hundred species of trees—a number equal to the total tree diversity of North America;

A single rainforest reserve in Peru is home to more species of birds than the entire United States;

One single tree in Peru was found to harbor forty-three different species of ants—a total that approximates the entire ant species in the British Isles.

It is estimated that a single Hectare of Amazon rainforest contains about 900 tons of living plants.

According to http://www.ran.org/info_center/factsheets/04b.html, the current rate of destruction in the main relevant countries is

| | ORIGI- | PRESENT | CURRENT |
|---|---|---|---|
| | NAL | EXTENT | AMOUNT OF |
| | EXTENT | OF | ANNUAL |
| | OF | PRIMARY | DESTRUCTION |
| | FOREST | FOREST | (in square km |
| COUNTRY (in sq km) | COVER | COVER | and in % per year) |
| Bolivia (1,098,581) | 90,000 | 45,000 | 1,500 (2.1%) |
| Brazil (8,511,960) | 2,860,000 | 1,800,000 | 50,000 (2.3%) |
| C. America (522,915) | 500,000 | 55,000 | 3,300 (3.7%) |
| Columbia (1,138,891) | 700,000 | 180,000 | 6,500 (2.3%) |
| Congo (342,000) | 100,000 | 80,000 | 700 (.8%) |
| Ecuador (270,670) | 132,000 | 44,000 | 3,000 (4.0%) |
| Indonesia (1,919,300) | 1,220,000 | 530,000 | 12,000 (1.4%) |
| Cote D'Ivoire (322,463) | 160,000 | 4,000 | 2,500 (15.6%) |
| Laos (236,800) | 110,000 | 25,000 | 1,000 (1.5%) |
| Madagascar (590,992) | 62,000 | 10,000 | 2,000 (8.3%) |
| Mexico (1,967,180) | 400,000 | 110,000 | 7,000 (4.2%) |
| Nigeria (924,000) | 72,000 | 10,000 | 4,000 (14.3%) |
| Philippines (299,400) | 250,000 | 8,000 | 2,700 (5.4%) |
| Thailand (513,517) | 435,000 | 22,000 | 6,000 (8.4%) |

The change must be done now, because the common wisdom so far has been that it is not urgent to take action, assuming that eventually something will be done if things get “too bad”. So unless humans realize that this wrong thinking is what has already brought us so far, the postponing of action is going to continue until the planet is irrevocably destroyed within less than one generation. Never in any time in history has any species on this planet caused so much destruction in so little time, otherwise life on this planet would have been destroyed almost completely eons ago. Various attempts have been made to motivate change, such as for example selling rainforest products that are obtained by sustainable harvesting, without destroying them, as is being done for example by Leslie Taylor, who showed that this can bring much more value per acre than destroying it, as explained below. But something was still clearly lacking, since the extent of these operations has still been very small. The main problem with this approach is that it takes time to build sufficient markets for these products and also many areas are currently inaccessible for such harvesting, so in the meantime the rest of the forest continues to be destroyed. An alternative approach has been encouraging people to donate for buying acres of the rainforests in order to save them from destruction, or even allowing people to more or less buy these acres, but many times these acres were still destroyed, because having bought it on paper still did not prevent locals from keeping destroying them. And donations clearly were not sufficient since even caring people usually only donate only relatively low amounts, whereas if a much bigger financial incentive is created, such as a real fair and lucrative investment, people will usually be ready to invest much more in it, and also much more people will want to take part in it. So clearly new approaches are needed to bring about the urgent drastic changes that are needed, by making it much more lucrative to almost anyone (for example people, and even various companies or organizations) to invest in saving the rainforests. This is clearly possible, since multinational companies that destroy the rainforests typically pay to the respective governments $2 or less for each acre that they irrevocably destroy, while taking advantage of the fact that these governments are usually suffering from heavy International debts. This is clearly ridiculous and is at the root of the folly, since clearly an indispensable natural resource of the planet is severely undersold, while its real value to the planet, in its undestroyed form, is worth many times more than that. In fact, According to an article by Peters C. M., Gentry A. H., and Mendelsohn R. O., “Valuation of an Amazonian Rainforest”, Which appeared in 1989 in Nature Magazine, Vol. 339, pp 655-656, as quoted by ran.org, the real Economic Value of One Hectare in the Peruvian Amazon is: $6,820 per year if intact forest is sustainably harvested for fruits, latex, and timber; $1,000 if clear-cut for commercial timber (not sustainably harvested), and $148 if used as cattle pasture. According to Leslie Taylor, calculations show that “if the medicinal plants, fruits, nuts, oils and other resources like rubber, chocolate and chicle (used to make chewing gums), were harvested sustainably, rainforest land has much more economic value today and more long term income and profits than if just timber were harvested or if it were burned down for cattle or farming operations. In fact, the latest statistics prove that rainforest land converted to cattle operations yields the land owner $60 per acre and if timber is harvested, the land is worth $400 per acre. However, if these renewable and sustainable resources are harvested, the land will yield the land owner $2,400 per acre. This value provides an income not only today, but year after year—for generations”.

For example in 20 years from now, after all the rainforests have been destroyed, people will be willing to pay almost any price in order to be able to go back in time and get these rainforest acres back, but it will be too late. Therefore it must be possible to motivate them to do it now instead of after it becomes too late.

### SUMMARY OF THE INVENTION

The present invention tries to solve this horrible situation by creating an organization and method for motivating as many people as possible to take immediate action. This is done preferably in at least one of the following preferable ways, but preferably a combination of most or all of them:

1. Preferably the idea of sustainable harvesting is combined with the idea of selling real acres to people. So instead of buying something only on paper, preferably an organization or multiple organizations are created, which make sure that the acres that were bought for example from the governments of the relevant countries, are indeed under supervision and protection and that preferably as many of them as possible are preferably also used for sustainable harvesting. Experience has shown that people are willing to pay even $20 or more per acre for buying land on the moon (http://moonshop.com) from a guy named Dennis Hope, whose legal rights to sell land on the moon are dubious. Yet the price that multinationals pay the governments of these countries for allowing them do destroy the rainforests is typically less than 2 dollars per acre. So it is quite possible to sell to people instead of barren acres on the moon, for a similar amount, rainforests acres that are streaming with life and are very well on the earth, together with guarding these acres and trying to make sure that these acres indeed become safe from destruction and that as many of them as possible are preferably eventually also used in a sustainable way. The acres themselves can be for example actual specific acres as defined for example by exact coordinates on a map, or for example virtual or “floating” acres, that are not bound to a single location but are more like shares in the organization that sells and takes care of these acres. Another possible variation is some combination of the above, so that for example people can choose the more general area, which can be broadly defined for example as which rainforest and/or which general part of it and/or for example some area of a few miles, and then within that area the exact acre may for example change according to various considerations or circumstances. Preferably the selling of the acres is conditional upon acceptance by the buyer of various limitations on the allowed uses of them, so that for example if the buyer himself causes destruction of the trees or animal life in the land that he bought he can for example immediately lose all rights there and/or in other rainforest acres that he bought and/or preferably have to pay a large fine. Preferably the buyers of the acres can also get for example certain royalties from the sustainable harvesting. Another possible variation is that for participating in the profits the owners have to pay for example also for additional investments needed per acre in order to run the sustainable harvesting.

2. Another possible variation is to use time limitations in the marketing scheme, both in order to motivate people to act faster and in order to emphasize and constantly remind them that the time is indeed very limited since the destruction is going on relentlessly all the time. This can be accomplished for example by setting clear rules that increase the price per acre according to the percent of rainforests remaining all the time. However, this implementation has the dangerous disadvantage that it might encourage some unscrupulous people or organization to buy up rainforest land and then continue to encourage the destruction in other parts of the rainforests on purpose in order to drive up the price of the rainforest land that they already bought. A better variation is to define a constant time scheme that is independent of the actual rate of destruction, such as for example determine that the price per acre will go up each month for example by 1% (or any other reasonable percent) or for example by a constant sum, such as for example 50 cents each month, etc., regardless of the rate of destruction.

3. Another possible variation is to give reductions in price according to quantity, so that the more acres someone buys, the less he has to pay per acre.

4. Another possible variation is to use various forms of “viral” or multilevel marketing, so that people have a direct incentive for telling more friends about this and convincing them to buy additional land, which is something missing for example from the dubious moon-acres marketing. So for example if a real rainforests acre costs for example $30 to a simple buyer, preferably he can get back for example $5 for each additional friend that he convinces to also buy an acre. Preferably this can be repeated for any amount of acres, or for example the more acres sold, the bigger the reduction to the buyer and preferably also the bigger the percent of bonus for the person who brought that buyer, so that for example if someone buys for example 100 acres, he has to pay only for example $22 per acre, and the person who brought him preferably gets a commission of for example $6 per acre sold through him. Another possible variation is to repeat this structure exponentially so that for example each person gets some commission (preferably a reduced one) also for each sale brought about by someone which he/she brought into the organization, so that for example if person A sells an acre to person B, he gets for example $5 commission for each acre sold, and if then person B sells an acre to person C, person A still gets for example a commission of $0.5 for this sale. Preferably, various limitations are added in order to limit the costs of this to the organization, so that for example this chain is limited to a certain length and/or to a certain maximum cumulative commission allowed and/or for example to a certain amount of deals and/or of acres sold. Another possible variation for adding even more to the safety of the people getting involved is adding the improvement that users can for example preferably have an option of delayed payment, so that they can for example buy the acres temporarily without paying for them and then have a grace period of for example 1-3 months for actually paying and keeping the acres, so that in the meantime they can see if they can sufficiently continue selling acres to others and getting those others to preferably sell to additional others, so that before the end of the grace period they can already have a good estimate if it was worth it, even before they have to spend a single real dollar. Another possible variation is that this does not have to be an all-or-nothing decision, so that the buyer can for example decide to keep only some of the acres by paying for them, and then the others in which he didn't finalize the sale go back to the available pool. Also, preferably the participants don't have to buy acres in order to sell these acres or other acres to others, but can act as agents even without buying any acres themselves at all, thus still getting commissions for each sale. This way for example users can buy many more acres than they could normally afford, by simply selling more acres to others and encouraging them to help sell acres too, so that they can finance their buying by their commissions, and in addition, preferably through trial the period, they can know in advance more or less how their balance is going to look like before even having to spend any real money for finalizing their buying of acres. To the best of my knowledge this type of “safe testing period” has never been used in any multilevel marketing scheme in any area in the current state of the art. Of course, in this variation, preferably all commissions are also contingent, depending on the further buyer to actually make the deal real. In addition to this, preferably this structure can be traced for example on the Internet so that each user can know at all times how many “agents” are working in the logical tree below him at any time and/or preferably how many acres each of them sold and preferably what his credit status is at any time, etc.

5. Another possible variation is to issue for example, preferably in addition, at least once in a while also public stocks of the organization itself, so that more funds can be gained for supporting its causes and especially for buying as many acres as possible in advance.

Of course, various combinations of the above and other variations can also be used, both within the solutions and across them.

Another problem is how to make sure that the rainforest lands bought indeed become protected, preferably in an efficient and cost-effective way, and how to start indeed sustainable harvesting in these lands. Of course, sustainable harvesting cannot be done at once in all the areas, and is also limited for example by market forces, such as for example the current world demand for a certain product, and the lack of accessibility to many areas. Therefore, preferably the organization does not guarantee that each acre will be used for producing anything but only for example that it will do its best to implement it in as many acres as possible. Therefore, when it comes to the sustainable harvesting, preferably each buyer becomes a partner in the total income of the organization from the sustainable harvesting, preferably proportionally to the number of acres that he owns. Various preferable solutions are possible for guarding the bought acres against destruction:

1. Making deals with the respective governments so that by getting the much higher prices per acre than the $2 or less that they get for allowing to destroy each acre, they will also be obliged to guard at least the bought areas for example by Extended police forces and/or by parts of the army, and/or for example by other special forces designated for this. Another possible variation is that preferably the governments have to agree in return to change the laws if needed so that destroying rainforest lands and/or especially any of the lands that were already paid for, becomes punishable by preferably huge fines and preferably also imprisonments, so that even without intensive guard all the time, the motivation for destroying rainforests becomes much lower.

2. Making deals with the local populations and/or with indigenous natives, wherein they are paid for example a certain amount per month to guard large areas or at least to issue a warning immediately as soon as they spot dangerous or suspect activities, etc. However, this creates additional monthly expenses, so if used, it is preferably combined with at least some sustainable harvesting which can thus help cover these monthly expenses. In this case, preferably the same locals used for guarding the areas are preferably also employed for the sustainable harvesting. In fact, letting local people work for the sustainable harvesting and preferably also get additional revenues from the profits from the sustainable harvesting is very preferable, since otherwise they themselves take part in the destruction. Another possible variation is to use, in addition or instead, hi-tech surveillance, such as for example through preferably low orbiting satellites, and/or for example zeppelins and/or balloons, that preferably report, preferably in real time, the conditions of the entire rainforests or at least large parts of them, so that any suspect or dangerous events can preferably be instantly spotted and appropriate action can be taken.

3. Creating different sources for fuel and for wood than rainforests, thus supplying the demand and removing much of the incentives that currently exist for continuing to destroy the rainforests. This can be done for example by encouraging and promoting the use of fast-growing plants that can easily replace wood, such as for example Kanef and/or industrial Hemp, which make in fact better wood fibers than ordinary trees and grow much faster. Hemp can grow for example to the size of a full tree within a few months, and has longer and better fibers than normal wood, so it can be used for example for creating better logs and/or fiber-boards, and can be also used for example for extracting Biomass fuel, for example in the form of Methylic Alcohol, which is much less polluting than current Gasoline, and is of course much more sustainable. Some of these plants can even be planted in rainforests lands that were already destroyed and deserted, since these are very resilient plants that can grow even is such destroyed places.

4. Preferably, in addition to the above, Class Action suits are filed, preferably against the multi-national organizations who destroy rainforests and/or against governments that allow it, on account of crimes against humanity, which are therefore relevant to the entire 6 billion humans that inhabit this planet and also to their progeny, who will all suffer the consequences of these acts.

Of course, various combinations of the above and other variations can also be used, both within the solutions and across them.

Important Clarification and Glossary:

Throughout the patent when variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable subcombination. “User” or “users” or “buyer” or buyers” as used throughout the patent, including the claims, can interchangeably be either single or plural, and can refer to both sexes even when words such as for example “he” or “she” or “his” or “her” are used. Although the land units have been described for convenience mainly in acres, this is just an example, so thought the patent, including the claims, “acre” can mean an actual acre, or any other convenient units or sub-units of area. Throughout the patent, including the claims, the words “organization” or “organizations” can interchangeably mean either single or plural organizations.

### DETAILED DESCRIPTION OF THE PREFERRED EMBODIMENTS

All of the descriptions in this and other sections are intended to be illustrative examples and not limiting.

The above preferable solutions are hereby described in more detail:

1. Preferably the idea of sustainable harvesting is combined with the idea of selling real acres to people. So instead of buying something only on paper, preferably an organization or multiple organizations are created, which make sure that the acres that were bought for example from the governments of the relevant countries, are indeed under supervision and protection and that preferably as many of them as possible are preferably also used for sustainable harvesting. Experience has shown that people are willing to pay even $20 or more per acre for buying land on the moon (http://moonshop.com) from a guy named Dennis Hope, whose legal rights to sell land on the moon are dubious. Yet the price that multinationals pay the governments of these countries for allowing them do destroy the rainforests is typically less than 2 dollars per acre. So it is quite possible to sell to people instead of barren acres on the moon, for a similar amount, rainforests acres that are streaming with life and are very well on the earth, together with guarding these areas and trying to make sure that these acres (and preferably also as many other unsold acres as possible) indeed become safe from destruction and that as many of them as possible are preferably eventually also used in a sustainable way. The acres themselves can be for example actual specific acres as defined for example by exact coordinates on a map, or for example virtual or “floating” acres, that are not bound to a single location but are more like shares in the organization that sells and takes care of these acres. Another possible variation is some combination of the above, so that for example people can choose the more general area, which can be broadly defined for example as which rainforest and/or which general part of it and/or for example some area of a few miles, and then within that area the exact acre may for example change according to various considerations or circumstances. Preferably users can also name acres after their name or after names of others and are preferably encouraged also for example to buy them as gifts to friends and relatives. Preferably users can also see their bought acres or at least their general area or areas, for example by live feed on the Internet, for example through satellites and/or balloons and/or zeppelins. Preferably there are various zoom functions available and the users can focus on various areas, and preferably interactive maps are available that show in real time for example areas already bought, areas not bought yet, areas that are already destroyed, areas that are currently being destroyed, etc. This is preferably done by using multiple, preferably wide angle, cameras on preferably multiple zeppelins and/or balloons and/or satellites, and/or allowing the users also to give remotely various commands to at least some of said cameras, such as for example changing angle and/or focus. Another possible variation is that various cameras for example constantly rotate and/or change focus and the users can view various areas based on the recently acquired relevant images. Preferably people can see on the Internet all the time the current status of the amount of acres bought and sold by the organization and also preferably a constant update on the rates and areas of continuing destruction. Another possible variation is that people can also see for example the lists of all those who already bought acres and/or the amounts they bought, except for example in case certain buyers explicitly request to remain anonymous. In case that any of relevant governments do not agree for example to the acres becoming fully owned by foreign citizens, preferably the selling is done so that at least some ownership rights remain also in local hands or in the hands of these governments. For example in Brazil and in Peru foreign citizens are not allowed by law to buy land, so at least for the countries that have these limitations, preferably instead of the acres themselves, for example what is sold is only the sustainable harvesting rights for example for the next 10 years or next 100 years, etc. Another possible variation is that what is sold is for example preferably a lease—for example for the next 100 years, while officially the land still remains for example under the ownership of the government or for example under the ownership of a branch of the organization that is locally incorporated, so that for example the organization really buys the acres but the clients only lease them for a time that to a human seems like forever but for Nature is nothing. Another possible variation is that the buyers just buy shares in the organization, except that the organization is preferably compelled to buy for each acre paid for at least one real acre of rainforests, so that the buyers know that they paid for a real acre, thus both saving the rainforests, and getting the right to really own such an acre (except of course for the limitation that they may use it only according to the limitations set by the organization). Therefore, preferably the selling of the acres is conditional upon acceptance by the buyer of various limitations on the allowed uses of them, so that for example if the buyer himself causes destruction of the trees or animal life in the land that he bought he can for example immediately lose all right there and/or in other acres that he bought and/or preferably have to pay a large fine. Preferably the buyers of the acres can also get for example certain royalties from the sustainable harvesting. Another possible variation is that for participating in the profits of the sustainable harvesting the owners have to pay for example also for additional investments needed per acre in order to run the sustainable harvesting. The entire scheme is based on the assumption that if the governments of the rainforest areas are paid considerably more per acre by the organization than what they get for example from multinational organizations that pay for example $2 for each acre that they irrevocably destroy, then they will prefer to sell to the organization. Preferably they will even more prefer to sell to the organization, when they take into consideration that this way in fact they are saving the rainforests instead of destroying them, and during the process get much more compensation for them. Preferably the governments get also, in addition, for example some percent of the revenues from the sustainable harvesting, for example in the form of taxes and/or additional commission. Preferably the organization itself is a non-profit organization, so that most or all of the profits go back to further helping to save the rainforests (except for example money needed for advertising, Public Relations, etc.), and thus also people will have more sympathy and trust towards it. Preferably the contract that the buyers have to agree to includes also acknowledging also the rights of the indigenous natives who populate these areas, such as for example the Amazonian Indian, so that they also become part of the process to the extent possible. Of course the acres are preferably not purchased one by one but in preferably large bunches, which makes overhead and paperwork costs much cheaper. This can be done by either the organization buying each time a sufficiently large bunch in advance, and/or for example accumulating orders together for example each month or more (or any other convenient time period) and only then doing the actual purchase as one transaction. This way all the licensing fees and other related expenses are also done preferably in large bunches, preferably in advance, even for example for acres not bought yet, which means that the overhead cost per single acre should become negligible. Similarly, for example harvesting experts are used preferably for determining the harvesting recommendation for large areas each time and not on an individual acre basis. Preferably, the best and largest rainforest lands owned by the government are located and bought from the government at a fixed price and fixed procedure for example after reaching an agreement that will be used also for all later purchases. Of course, preferably the buyers can share also other potential revenues from the sold and/or leased areas, such as for example tourism, revenues from displaying live feeds, etc. Another possible variation is preferably planting and growing at least in some areas various additional appropriate plants and/or trees that can preferably be used for food in these areas in a way that doesn't damage the existing trees, plants, animals, and/or soil (These are preferably indigenous plants that already exist in the area. However, if this is done, it must be done carefully so as not to disrupt ecological balances).

2. Another possible variation is to use time limitations in the marketing scheme, both in order to motivate people to act faster and in order to emphasize and constantly remind them that the time is indeed very limited since the destruction is going on relentlessly all the time. This can be accomplished for example by setting clear rules that increase the price per acre according to the percent of rainforests remaining all the time. However, this implementation has the dangerous disadvantage that it might encourage some unscrupulous people or organization to buy up rainforest land and then continue to encourage the destruction in other parts of the rainforests on purpose in order to drive up the price of the rainforest land that they already bought. A better variation is to define a constant time scheme that is independent of the actual rate of destruction, such as for example determine that the price per acre will go up each month for example by 1% (or any other reasonable percent) or for example by a constant sum, such as for example 50 cents each month, etc., regardless of the rate of destruction.

3. Another possible variation is to give reductions in price according to quantity, so that the more acres someone buys, the less he has to pay per acre.

4. Another possible variation is to use various forms of “viral” or multilevel marketing, so that people have a direct incentive for telling more friends about this and convincing them to buy additional land, which is something missing for example from the dubious moon-acres marketing. So for example if a real rainforests acre costs for example $30 to a simple buyer, preferably he can get back for example $5 for each additional friend that he convinces to also buy an acre. Preferably this can be repeated for any amount of acres, or for example the more acres sold, the bigger the reduction to the buyer and preferably also the bigger the percent of bonus for the person who brought that buyer, so that for example if someone buys for example 100 acres, he has to pay only for example $22 per acre, and the person who brought him preferably gets a commission of for example $6 per acre sold through him. Another possible variation is to repeat this structure exponentially so that for example each person gets some commission (preferably a reduced one) also for each sale brought about by someone which he/she brought into the organization, so that for example if person A sells an acre to person B, he gets for example $5 commission for each acre sold, and if then person B sells an acre to person C, person A still gets for example a commission of $0.5 for this sale. Preferably, various limitations are added in order to limit the costs of this to the organization, so that for example this chain is limited to a certain length (for example up to N levels in the tree) and/or to a certain maximum cumulative commission allowed and/or for example to a certain amount of deals and/or of acres sold. This multilevel marketing is of course similar to various Pyramid schemes, except that in this case there is a very real product, and also it is for a very good cause. However, there are also additional Improvements, as explained below: Another problem with normal “Pyramid Schemes” is that many times people are afraid to lose money if they are not successful in selling the product forward, such as for example in the case of products like “Lifestiles”, in which each participant is required to spend an expensive sum just to “get into the game”. However, the real danger and the real test for the legitimacy of any Pyramid scheme depends clearly on the nature of the “product” sold, since if the product is not worth the money paid for it, than obviously the only profit can come from selling it in time to a greater “sucker” who is willing to pay more for it, until certainly there will come a time where the buyers are no longer able to sell it to other buyers, and then the entire “Pyramid” crushes. An example of this is for example during a stock market bubble, such as happened for example with the NASDAQ before the crash that began at the end of March 2000, when people bought stocks clearly many times above their real value, but still thought they will be able to get out in time by selling it to someone else who will still be willing to pay more in the hope of also making some “quick buck” and exiting. On the other hand, when the value of the product is real, and preferably no unregulated speculation is allowed, then clearly no crash at the end is expected, since even the last buyers should have no problem. Therefore, in order to prevent later speculation and/or to prevent circumventing the purposes of the organization, preferably when anyone buys one or more acres the selling contract itself is conditional so that he may not resell his rainforest acres or other rainforest acres except to persons who also agree to the same terms, and may sell it only according to the prices allowed by the organization at that time. Another possible variation for adding even more to the safety of the people getting involved is adding the improvement that users can for example preferably have an option of delayed payment, so that they can for example buy the acres temporarily without paying for them and then have a grace period of for example 1-3 months (or any other convenient or reasonable period) for actually paying and keeping the acres, so that in the meantime they can see if they can sufficiently continue selling acres to others and getting those others to preferably sell to additional others, so that before the end of the grace period they can already have a good estimate of how many acres they can afford or if it was worth it, even before they have to spend a single real dollar. (The same grace period is preferably automatically applicable at all levels of the tree, so that the moment someone agrees to buy he/she preferably has automatically the same standard grace period to decide. Another possible variation is that the buyer is limited to the same grace period of the person that sells to him/her, so that for example if the seller has only part of his grace period left for given acres, the people that buy through him are preferably limited in those acres to the same remaining part of the grace period that the seller has). Another possible variation is that the grace period is for example dependent on the amount of acres involved in each deal. Another possible variation is that preferably users can buy acres from the organization at cheaper rates depending on the amount of acres that they have already bought and/or sold so far. Another possible variation is that this does not have to be an all-or-nothing decision, so that the buyer can for example decide to keep only some of the acres by paying for them, and then the others in which he didn't finalize the sale preferably go back to the available pool. Another possible variation is that at least some small deposit needs to be made in advance on account for each acre bought, which is nonrefundable if the buyer cancels. Also, unlike Lifestiles for example, preferably the participants don't have to buy acres in order to sell these acres or other acres to others, but can act as agents even without buying any acres themselves at all, thus still getting preferably the same or different commissions for each sale. This way for example users can buy many more acres than they could normally afford, by simply selling more acres to others and encouraging them to help sell acres too, so that they can finance their buying by their commissions, and in addition, preferably through the trial period, they can know in advance more or less how their balance is going to look like before even having to spend real money for finalizing their buying of acres. To the best of my knowledge this type of “safe testing period” has never been used in any multilevel marketing scheme in any area in the current state of the art. Of course, in this variation, preferably all commissions are also contingent, depending on the further buyer to actually make the deal real. Another possible variation is that the more acres each person owns, the higher commission he can get for direct and/or indirect sales. In addition to this, preferably this structure can be traced by the users for example on the Internet so that each user can know at all times how many “agents” are working in the logical tree below him/her at any time and/or preferably how many acres each of them sold and preferably what his credit status is at any time, etc. A similar scheme to this (with any one or more of the above variations) can be used for example also for marketing any other real product for example on the Internet, and also for example for marketing stocks or shares for example in any Internet company, even without payment in advance, so that for example the users “play” with accumulating credit points, which can later become for example options that can be converted into real property when the company becomes of real value and thus the user can then have the choice of for example paying some real money and converting his options into real shares.

5. Another possible variation is to issue for example, preferably in addition, at least once in a while also public stocks of the organization itself, so that more funds can be gained for supporting its causes.

Of course, various combinations of the above and other variations can also be used, both within the solutions and across them. Altogether, since there are about 2 billion acres and about 6 billion humans on this planet, it means that theoretically on average it is sufficient that for example 1 in every 3 persons in the world will buy on average just 1 acre in order to save the entire remaining rainforest acres. Of course many people on the third world cannot afford even that, but on the other hand many people in the developed countries who understand the real value of this can buy much more than 1 acre, once they realize that on the long run this is one of the best investments they can ever make. Of course, someone like Bill Gates for example could buy the whole two billion acres alone. Of course the organization or organizations described here can also become an integral part of various governments, such as for example the government of Brazil itself.

Another problem is how to make sure that the rainforest lands bought indeed become protected, preferably in an efficient and cost-effective way, and how to start indeed sustainable harvesting in these lands. Of course, sustainable harvesting cannot be done at once necessarily in all the areas, and is also limited for example by market forces, such as for example the current world demand for a certain product. Therefore, preferably the organization does not guarantee that each acre will be used for producing anything but only for example that it will do its best to implement it in as many acres as possible. Therefore, when it comes to the sustainable harvesting, preferably each buyer becomes a partner in the total income of the organization from the sustainable harvesting, preferably proportionally to the number acres that he owns, and preferably additional investment is needed in order to participate in this, unless for example the buyer wants to go there and run the sustainable harvesting of his acres by himself. Various preferable solutions are possible for guarding the bought acres against destruction:

1. Making deals with the respective governments so that by getting the much higher prices per acre than the $2 or less that they get for allowing to destroy each acre, they will also be obliged to guard at least the bought areas for example by Extended police forces and/or by parts of the army, and/or for example by other special forces designated for this. Another possible variation is that the preferably governments have to agree in return to change the laws if needed so that destroying rainforest lands and/or especially any of the lands that were already paid for, becomes punishable by preferably huge fines and preferably also imprisonments and actually enforce these rules, so that even without intensive guard all the time, the motivation for destroying rainforests becomes much lower.

2. Making deals with the local populations and/or with indigenous natives, wherein they are paid for example a certain amount per month to guard large areas or at least to issue a warning immediately as soon as they spot dangerous or suspect activities, etc. However, this creates additional monthly expenses, so if used, it is preferably combined with at least some sustainable harvesting which can thus help cover these monthly expenses. In this case, preferably the same locals used for guarding the areas are preferably also employed for the sustainable harvesting. In fact, letting local people work for the sustainable harvesting and preferably also get additional revenues from the profits from the sustainable harvesting is very preferable, since otherwise they themselves take part in the destruction. According to Leslie Taylor, in Brazil for example the government encourages poor people to grab possession of forest lands and destroy them, with the motto of “land without men for men without land”, so that poor people squatter and destroy rainforest acres and create farms, but a short time afterwards the depleted land becomes useless and they have to move on to destroy more rainforest acres. Of course this motto also ignores the fact these the land are not really “without men” but are already populated by native Indians. She also quotes one Brazilian Official's public statement that “not until Amazonas is colonized by real Brazilians, not Indians, can we truly say we own it”. This attitude can lead to the sad realization that descendents of those same conquistadors who were directly or indirectly responsible for the depletion of these Indian populations during the last 500 years are also the ones who are now finishing the “job” of their ancestors by also destroying or allowing to destroy those rainforest lands for which they apparently don't have sufficient regard or appreciation of their true value. In order to stop this Locust-like behavior, clearly these masses of people have to be taken into account and become part of the solution. Another possible variation is to use, in addition or instead, hi-tech surveillance, such as for example through preferably low orbiting satellites, and/or for example zeppelins and/or balloons, which are much cheaper, that preferably report, preferably in real time, the conditions of the entire rainforests or at least large parts of them, so that any suspect or dangerous events can preferably be instantly spotted and appropriate action can be taken. Of course, since satellites are very expensive, preferably the organization uses services from existing surveillance satellites, such as for example NASA'a Terra MODIS Earth Observing Satellites. However another problem with satellites is that the stationary satellites that constantly cover the same area are at much higher orbit and thus have less resolution, whereas low orbiting satellites typically reach the same area only once every few hours or for example once a day or more, which might not be sufficient for real-time alerts. Preferably more Real-time alerts and more detailed data are used, because for example according to http://newsroom.msu.edu/news/archives/2003/02/rainforests.html, which quotes a recent report in Nature Magazine of Feb. 27, 2003, there are many small rainforests fires which can be easily stopped, but if neglected they can lead to subsequent huge intensity fires that are extremely difficult to put out. Zeppelins or balloons can be much cheaper and can remain constantly over the same areas and can still be also much lower than satellites. (The Zeppelins and/or balloons can be for example manned and/or for example small and preferably automatic or remote controlled. Preferably both types are used, for various purposes). Preferably these or other balloons or zeppelins are used also as one of the methods of carrying harvests from various areas, so that at least some of the problems of accessibility are solved this way. Preferably zeppelins and/or balloons can land for example in a few cleared areas that are preferably dispersed as needed or for example they stay above the canopy and the cargo is pulled up to them with ropes, which can for example be lowered from the zeppelin or balloon, or for example the rope is sent up with a smaller balloon and then the zeppelin pulls up the cargo that is attached to the rope on the ground. Preferably the zeppelins and/or balloons are powered by solar energy. Another possible variation is to use for example special vehicles that can move on any terrain without roads, for example vehicles that simulate animal legs, and/or for example use various animals that can carry cargo without roads. Another possible variation is to increase the price of the acres in order to finance also the guarding fee, so that for example as more acres are sold each month, they also help pay for the guarding of themselves and of the already sold acres. Theoretically of course guarding each acre separately would make it far too expensive, however since the acres are preferably parts of much larger clusters, the guarding is preferably more at the borders of these larger areas, so it is much cheaper when calculated as cost per acre, and it should become even cheaper per acre as more acres are sold. Anyway, if the organization can sustainably harvest for example even just 10% of the purchased acres and make for example just $1000 per acre per year by this, the average income per acre becomes $100 per year, which is quite enough for paying both for the guarding expenses and for the part of the profit that the client is entitled to, so that the organization can easily sustain itself. If for example the profit is $2400 per acre like Leslie Taylor's estimate or higher like for example the above higher estimate, and/or if a larger percent of the purchased acres can be sustainable harvested like this, then the figures are even much better.

3. Creating different sources for fuel and for wood than rainforests, thus supplying the demand and removing much of the incentives that currently exist for continuing to destroy the rainforests. This can be done for example by encouraging and promoting the use of fast-growing plants that can easily replace wood, such as for example Kanef and/or industrial Hemp, which make in fact better wood fibers than ordinary trees and grow much faster. Hemp can grow for example to the size of a full tree within a few months, and has longer and better fibers than normal wood, so it can be used for example for creating better logs and/or fiber-boards, and can be also used for example for extracting Biomass fuel, for example in the form of Methylic Alcohol, which is much less polluting than current Gasoline, and is of course much more sustainable. Some of these plants can even be planted in rainforest lands that were already destroyed and deserted, since these are very resilient plants that can grow even is such destroyed places. It should be kept in mind that in recent years, except for the USA and a few other countries, in much of the world growing industrial hemp is legal now, including for example In North America: Canada; in Western Europe at least: England, Germany, France, Spain, Portugal, Austria, Denmark, Holland, Ireland, Italy and Switzerland; In Eastern Europe at least: Russia, Hungary, Romania, Poland, Slovenia, Croatia, Czech Republic and Ukraine; In East Asia at least: China, India, Korea and Thailand; In south America: At least Chile and Nicaragua; and it is also legal for example in South Africa, in Egypt, and in New Zealand.

4. Preferably, in addition to the above, Class Action suits are filed, preferably against the multi-national organizations who destroy the rainforests and/or personally members of their managements that are involved in making these decisions and/or against governments and/or specific politicians that allow it, preferably on account of crimes against humanity, which are therefore relevant to the entire 6 billion humans that inhabit this planet and to their progeny who will all suffer the consequences of these acts. It is clear to see from the above descriptions of the consequences of destroying the rainforests that at least some of these consequences have an affect on every living creature on this planet, including the humans. Preferably these class suits are filed, to the extent possible, both in the countries where the destruction takes place, and in the countries where the centers of these multinational corporations are located, such as for example in the USA. Another possible variation is to try to file them also in any other country where the class suit system is sufficiently developed to allow this, since the victims are in every country on this planet. This is important both for bringing these issues more to the consciousness of everyone (since each such class action can get large media coverage), and for halting these organizations, since otherwise organizations that buy acres for $2 and make instantly $400 per acre have more buying power than an organization as described in this invention, who's income is based more on the long run. This is also important for showing those multinationals and governments that they ARE indeed accountable for what they are doing and will have to account for their actions now or in the future, in a way that preferably will also hurt them deeply in their pockets, and cannot escape or hide behind the claim that they are not the only ones responsible. However, since most of these governments are very poor, preferably those rich multinationals are sued also for paying back damages for the destruction already caused by them, whereas these governments are preferably sued only for future damages unless they immediately change their policies that allow the destruction to go on. Another possible variation is to also try to put on trial some of the above parties in the International tribunal in Hague for crimes against humanity. There is no problem of financing this, since class suits are almost invariably done by contingency lawyers, so there are practically no costs to the organization. These huge class action suits will probably eventually occur anyway, if not now, then after much more additional destruction has occurred or after the rainforests are completely gone, so it is much more preferable to do it now, while it can still lead to preventing a lot of the damage that is about to occur during the next few years. Another possible variation is, preferably in combination with these class action suits, to encourage consumer groups to boycott various products and/or companies that are responsible for large scale destruction of rainforests, such as for example Cow products from cows that are raised in these areas, etc. In addition, preferably the organization uses profits from the marketing of the acres and/or from the sustainable harvesting to invest in ecological education, preferably both in the countries where the main rainforests exists and also in other countries.

Of course, various combinations of the above and other variations can also be used, both within the solutions and across them.

While the invention has been described with respect to a limited number of embodiments, it will be appreciated that many variations, modifications, expansions and other applications of the invention may be made which are included within the scope of the present invention, as would be obvious to those skilled in the art.

I claim:

1. A method for saving rainforests comprising the steps of:
a. Selling and/or leasing rainforest areas to people;
b. Guarding said areas; and:
c. Making the selling and/or leasing of said areas conditional upon acceptance by the buyers of various limitations on the allowed uses of them.

2. The method of claim 1 wherein said selling and/or leasing of areas to people is combined with sustainable harvesting to the extent possible.

3. The method of claim 2 wherein at least one of the following features exists:
a. The buyers have to invest additional funds if they want their areas to become part of the sustainable harvesting.
b. The sustainable harvesting is done only in some of the areas and the profits from the sustainable harvesting are shared between the areas owners proportionally to their holdings.

4. The method of claim 1 wherein the areas are at least one of:
a. Actual specific areas.
b. Virtual areas that are not bound to a single location
c. Areas where the buyers can choose a more general area and then within that area the exact area may change.

5. The method of claim 1 wherein at least one of the following features exists:
a. The price per unit increases in reverse to the percent of rainforests remaining.
b. The price per unit constantly increases at certain time intervals independently of the actual rate of destruction.

6. The method claim 1 wherein there are reductions in price according to quantity, so that the more areas someone buys, the less he has to pay per unit.

7. The method of claim 1 wherein multilevel marketing is also used, so that people have a direct incentive for telling more friends about this and convincing them to buy additional rainforest lands.

8. The method of claim 7 wherein at least one of the following features exists:
a. Each person gets some commission also for sales brought about by someone which he/she brought into the organization, at least until a certain chain length and/or until a certain maximum cumulative commission is reached.
b. Users can have an option of delayed payment, so that they can buy the areas temporarily without paying for them and then have a grace period for actually paying and keeping the areas or part of them.
c. The participants don't have to buy areas in order to sell areas to others, but can also act as agents even without buying any areas themselves at all, thus still getting the commissions for each sale.
d. The multi-level structure can be traced on the Internet so that each user can know at all times at least one of how many “agents” are working in the logical tree below him at any time and how many areas each of them sold and what his credit status is at any time.
e. In addition, at least once in a while, also public stocks of the organization itself are offered, so that more funds can be gained for supporting its causes.
f. Users have to make at least some small non-refundable deposit for each unit, which remains paid even if they eventually choose not to buy the unit.
g. Users can buy acres from the organization at cheaper rates depending on the amount of acres that they have already bought and/or sold so far.

9. The method claim 1 wherein deals are made with the respective governments so that by getting the higher prices per acre than the small amount that they get for allowing to destroy each acre, said governments also agree to at least one of:
a. Guard the bought areas by at least one of police, army forces, and special forces designated for this.
b. Change the laws if needed and enforce them, so that destroying rainforest lands becomes punishable by at least one of large fines and imprisonment.

10. The method of claim 1 wherein deals are made with at least one of the local populations and indigenous natives, wherein at least one of:
a. They are paid to guard areas or at least to issue a warning immediately when they spot dangerous or suspect activities
b. They are also employed for sustainable harvesting.
c. They are getting revenues from sustainable harvesting.

11. The method of claim 1 wherein hi-tech surveillance is used in order to report in real time the conditions of large areas, based on at least one of:
a. Stationary Satellites that consecutively cover the same area.
b. Low orbit satellites which cover the desired areas intermittently.
c. At least one of zeppelins and balloons.
d. Other hitech surveillance means.

12. The method of claim 1 wherein alternate sources for at least one of fuel and wood are encouraged, thus supplying the demand and removing much of the incentives that currently exist for continuing to destroy the rainforests.

13. The method of claim 12 wherein at least one of hemp or Kenaf or other fast growing plants are grown and used for at least one of wood and energy instead of rainforest trees.

14. An organization for saving the rainforests based on a combination of:
a. Selling and/or leasing rainforest areas to people;
b. Guarding said areas; and:
c. Making the selling and/or leasing of said areas conditional upon acceptance by the buyers of various limitations on the allowed uses of them.

15. The organization of claim 14 wherein said selling and/or leasing of areas to people is combined with sustainable harvesting to the extent possible.

16. The organization of claim 15 wherein at least one of the following features exists:
a. The buyers have to invest additional funds if they want their areas to become part of the sustainable harvesting.
b. The sustainable harvesting is done only in some of the areas and the profits from the sustainable harvesting are shared between the areas owners proportionally to their holdings.

17. The organization of claim 14 wherein the areas are at least one of:
a. Actual specific areas.
b. Virtual areas that are not bound to a single location
c. Areas where the buyers can choose a more general area and then within that area the exact area may change.

18. The organization of claim 14 wherein at least one of the following features exists:
a. The price per unit increases in reverse to the percent of rainforests remaining.
b. The price per unit constantly increases at certain time intervals independently of the actual rate of destruction.

19. The organization claim 14 wherein there are reductions in price according to quantity, so that the more areas someone buys, the less he has to pay per unit.

20. The organization of claim 14 wherein multilevel marketing is also used, so that people have a direct incentive for telling more friends about this and convincing them to buy additional rainforest lands.

21. The organization of claim 20 wherein at least one of the following features exists:
a. Each person gets some commission also for sales brought about by someone which he/she brought into the organization, at least until a certain chain length and/or until a certain maximum cumulative commission is reached.
b. Users can have an option of delayed payment, so that they can buy the areas temporarily without paying for them and then have a grace period for actually paying and keeping the areas or part of them.
c. The participants don't have to buy areas in order to sell areas to others, but can also act as agents even without buying any areas themselves at all, thus still getting the commissions for each sale.
d. The multi-level structure can be traced on the Internet so that each user can know at all times at least one of how many “agents” are working in the logical tree below him at any time and how many areas each of them sold and what his credit status is at any time,
e. In addition, at least once in a while, also public stocks of the organization itself are offered, so that more funds can be gained for supporting its causes.
f. Users have to make at least some small non-refundable deposit for each unit which remains paid even if they eventually choose not to buy the unit.
g. Users can buy acres from the organization at cheaper rates depending on the amount of acres that they have already bought and/or sold so far.

22. The organization of claim 14 wherein deals are made with the respective governments so that by getting the higher prices per acre than the small amount that they get for allowing to destroy each acre, said governments also agree to at least one of:
a. Guard the bought areas by at least one of police, army forces, and special forces designated for this.
b. Change the laws and enforce them, so that destroying rainforest lands becomes punishable by at least one of large fines and imprisonment.

23. The organization of claim 14 wherein deals are made with at least one of the local populations and indigenous natives, wherein at least one of:
a. They are paid to guard areas or at least to issue a warning immediately when they spot dangerous or suspect activities
b. They are also employed for sustainable harvesting.
c. They are getting revenues from sustainable harvesting.

24. The organization of claim 14 wherein hi-tech surveillance is used in order to report in real time the conditions of large areas, based on at least one of:
a. Stationary Satellites that consecutively cover the same area.
b. Low orbit satellites which cover the desired areas intermittently.
c. At least one of zeppelins and balloons.
d. Other hitech surveillance means.

25. The organization claim 14 wherein alternate sources for at least one of fuel and wood are encouraged, thus supplying the demand and removing much of the incentives that currently exist for continuing to destroy the rainforests.

26. The organization of claim 14 wherein at least one of hemp or Kenaf or other fast growing plants are grown and used for at least one of wood and energy instead of rainforest trees.

27. The method of claim 1 wherein Class Action suits are filed against at least one of multi-national organizations who destroy the rainforests, individual members of their managements, relevant governments, and specific politicians that allow it, on account of at least one of crimes against humanity and damages caused to humanity.

28. The method of claim 27 wherein the multinational organization are sued also for paying back damages for the destruction already caused by them, and the governments are sued only for future damages unless they immediately change their policies that allow the destruction to go on.

29. The method of claim 1 wherein at least in countries that have limitations on buying these lands, at least one of the following features exists:
a. Instead of the areas themselves, what is sold is at least one of: Only the sustainable harvesting rights for a certain period, or a lease.
b. At least one of the government and the organization really owns the areas, but the clients only lease them.

30. The method of claim 1 wherein the areas are purchased in large bunches, in order to reduce overhead costs, by at least one of: buying each time a sufficiently large bunch in advance, and accumulating orders together and only then doing the actual purchase as one transaction.

31. The method of claim 1 wherein the buyers can share also other potential revenues from the sold and/or leased areas.

32. The method of claim 1 wherein users can view interactively rainforests areas and at least one of the following features exists:
a. Users can see their bought acres or at least their general area or areas, by live feed on the Internet, for through satellites and/or balloons and/or zeppelins.
b. There are various zoom functions available and the users can focus on various areas.
c. There are multiple cameras on zeppelins and/or balloons and/or satellites.
d. Users cam give remotely various commands to at least some of the cameras.
e. Various cameras constantly rotate and/or change focus and the users can view various areas based on the recently acquired relevant images.

33. The method of claim 1 wherein balloons and/or zeppelins are used as one of the methods of carrying harvests from various areas and at least one of the following features exists:
a. Said zeppelins and/or balloons can land in cleared areas.
b. Said zeppelins and/or balloons stay above the canopy and the cargo is pulled up to them with ropes.
c. Said zeppelins and/or balloons stay above the canopy and the cargo is pulled up to them with ropes, and said ropes are lowered from the zeppelin or balloon, or the rope is sent up with a smaller balloon and then the zeppelin pulls up the cargo that is attached to the rope on the ground.
